(19) United States
(12) Patent Application Publication
(10) Pub. No.: US 2008/0195519 A1
(43) Pub. Date: Aug. 14, 2008

(54) SYSTEM AND METHOD FOR TRADING CREDIT DERIVATIVE PRODUCTS HAVING FIXED PREMIUMS

(75) Inventor: Richard John STEVENS, London (GB)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: LIFFE Administration and Management, London (GB)

(21) Appl. No.: 11/672,649

(22) Filed: Feb. 8, 2007

(51) Int. Cl. G06Q 40/00

(52) U.S. Cl. 705/37

(57) ABSTRACT

A system and method for facilitating trading of credit derivative products is provided. Each of the credit derivative products includes a fixed premium to be paid by a buyer to a seller on a predetermined periodic basis. For a given credit derivative product, an amount of the fixed premium may or may not be equal to a credit default swap par rate. When at least two of the credit derivative products have an identical underlying reference entity, an identical maturity date, and an identical fixed premium, the two products are consolidated into a single combined position. For a given credit derivative product, an amount of the fixed premium may be expressed either in basis points per annum or in cash value, or in any other format that can be understood by market participants. The fixed premium may be paid on a daily basis or on a quarterly basis, or on any other predetermined periodic basis.

### BACKGROUND OF THE INVENTION

1. Field of the Invention

The present invention relates to financial markets and derivative forms of financial products. More particularly, the invention relates to a system and method for facilitating trading of a credit derivative product that includes a fixed premium.

2. Related Art

Trading in credit risk exposure, or “credit derivatives”, has grown dramatically in recent years. Typically, all such trading activity is conducted through the “over-the-counter” (OTC) financial market. This trading mechanism is characterized by two counterparties privately negotiating a transaction. The nature of the transaction itself, and the mechanism by which it is negotiated can take many forms, for example:
The transaction itself may be a deal on industry standard terms, or may be unique and tailored to the specific requirements of either of the counterparties.
One counterparty may approach the other directly, or via a third party broker.
The negotiation may be done verbally or across private electronic networks. The latter is often done for transactions involving standardized products.

Once a transaction is completed, the two counterparties have a contractual relationship. This contract can take many forms. For example, party A may be required to deliver an asset to party B in exchange for payment. As another example, party A may be required to make cash payments to party B over a period of time in certain situations, and party B may be required to make cash payments to party A in certain other situations. Contractual obligations can exist for a considerable period of time, for example, 10 years or more.

Because deals are completed bilaterally, price quotations can take any form that is understood by both counterparties. However, for each type of instrument available in the market, a standard terminology has developed. In some instances, in particular that of Credit Default Swaps, standardization has been supported by the International Swaps and Derivatives Association (ISDA), who have established contractual standards and a common set of definitions.

Many types of institutions borrow money—for example, governments, mortgage companies, and corporations. Borrowing normally takes the form of either a bond or a loan. In case of a loan, this is usually repayable with interest added. In the case of a bond, interest payments usually take the form of a coupon paid periodically to bond holders. Buying a bond from an issuer is equivalent to lending money to the issuer. The borrower agrees to pay back a stated amount of money (i.e., the “principal” amount) at the end of the life of the bond. The principal does not necessarily equate to the amount of money borrowed, which is reflected in the issue price of the bond.

When lending money to an institution, the lender takes on a risk that the borrower will not be able to pay some or all of either the original amount of money lent or any interest payable, or that these payments will be delayed. This risk is the credit risk of the loan or bond. The term “credit event” is used to refer to a situation where one of these events occurs within the terms of a credit derivative contract. Other similar events may also be defined as being credit events, based on the agreement between the counterparties of credit derivative products.

Credit derivatives have developed to enable investors to manage the credit risk which exists within a portfolio of bonds and loans. As bonds are securities, and therefore more easily transferable, it is easier to conceptualize credit derivatives related to bonds, and many existing products relate only to bonds. However, the present invention is applicable to both bonds and loans.

One currently available credit product is known as a collateralized debt obligation (CDO). A CDO is not a derivative instrument, in the sense that it cannot be used by itself to control credit risk exposure. Instead, a CDO is a form of investment fund which invests in a portfolio of credit-risky bonds and other assets. To raise the capital to do this, the fund issues securities which provide a return to the investor based on the returns from the portfolio. Typically, a variety of securities are issued which have differing levels of exposure to the default risk of the underlying assets and differing levels of projected return. For example, a fund could issue a first tranche (i.e., one of a number of classes of security issued by an entity, such as a CDO fund, which have differing claims on the entity) of securities which will pay modest return to the investor, but this return will be unaffected by the first ten defaults of portfolio securities. The gives the investor a superior credit exposure compared to direct investment in the portfolio. The second tranche of securities issued, for example, could offer a higher potential return on investment, but with the trade-off that security returns will be affected by all defaults in the portfolio, with payments on the security ceasing altogether after five defaults. CDOs enable investors to obtain a credit exposure which meets their requirements, but are not designed to alter the credit exposure of an existing investment position.

The main product type used for credit risk transfer is the credit default swap (CDS). In this structure, an investor can buy protection against a credit event occurring to an individual bond or to a portfolio of bonds. The investor pays an agreed amount of money—known as “premium”—on a periodic basis to the protection seller. If a credit event was to occur, the protection seller would compensate the protection buyer. The exact nature of the compensation will depend on the specific agreement between buyer and seller, but could, for example, require the protection seller to buy the bond from the protection buyer at par value (i.e., $100 per $100 nominal), or it could require the protection seller to make a single payment to the protection buyer reflecting the change in value of the underlying bond.

In some cases the CDS is written with reference to a particular issuer rather than a specific bond or loan. In this case, should there be a credit event, the protection buyer can choose which bond or loan is to be delivered. There is likely to be one bond or loan which is the most economically advantageous to deliver, in the case of a physically delivered contract, or to value, in the case of a cash settled contract. The premium amount is quoted as a percentage of the nominal amount of the bond per annum, and is typically paid once every three months.

A total return swap (TRS) is similar to a CDS in that two counterparties agree to transfer cash payments between each other. With a TRS, an investor can buy protection against a credit event by paying out the total return on the asset in exchange for receiving a regular premium amount. If the returns on the asset are negative in a given period (e.g., due to a credit event), then the protection buyer will take receipt of this amount. Payments made with a TRS are not related solely to credit events, as asset values can change due to a number of factors.

A credit option contract gives the buyer of the option the right to buy (in the case of a call option) or sell (in the case of a put option) an underlying asset or instrument at specified price at a specified time, or in a specified period. A premium is paid for the purchase of this right. A credit call option gives the buyer the right to buy an underlying credit-risky asset. A credit put option gives the holder the right to sell the underlying credit-risky asset. Options can also be purchased which give the holder the right to buy or sell the credit spread of a particular asset—i.e., the implied yield to maturity of the asset compared to that of government securities with the same maturity—at a specified level. Protection against a credit event could therefore be obtained, for example, by buying a credit put, or by buying a credit spread call.

Credit linked notes (CLNs) are linked to the credit performance of a single underlying asset. The issuer of a CLN is effectively the protection buyer. As with bonds, the note is paid for in full at the time of purchase, and the issuer subsequently pays coupons and a return of capital to the purchaser at maturity. The amount of the coupon and the amount of principal paid is affected by credit events in a specific underlying security. However, unlike the structure of a CDO, the issuer of the CLN need not own the reference asset.

Credit indices have been developed to create an instrument for standardized trading and for more transparent value measurement. There has been consolidation in the indices available, and there is now one major index for each of Europe, Asia and North America. These indices cover the whole corporate bond market, and are subdivided into indices covering the major industry sectors represented.

The iTraxx Europe Index has 125 constituent corporate entities. Each corporate entity has equal weight in the index—i.e., 0.8%. It is not an index in the sense that it has a specific index value; rather, it is a portfolio of names against which derivatives may be quoted. The corporate entities covered by the index are fixed. However, as capital market activity will affect the companies over time, a new index series is created every six months. Thus, in one month, CDSs may be quoted on iTraxx Europe series 3, and the next month, they may be quoted on iTraxx Europe series 4, which may have a widely different set of constituents.

A credit default swap can be taken out on an index in much the same form as on an individual corporate entity. In the case of a default by one of the constituent companies, a payment is made to the protection buyer to reflect the loss in value of the bond. However, the swap typically does not expire at that point; instead, it continues with a smaller intrinsic portfolio.

### SUMMARY OF THE INVENTION

In one aspect, the invention provides a system for facilitating trading of credit derivative products. The system includes one or more servers at which the credit derivative products are actively traded and/or processed, and an interface in communication with at least one of the one or more servers. The interface is configured to enable a user to enter a bid or an offer relating to a credit derivative product. Each of the credit derivative products includes a fixed premium to be paid by a buyer to a seller on a predetermined periodic basis. At least one of the one or more servers is configured to accept bids and offers for each of the credit derivative products via the interface. When at least two of the credit derivative products have an identical underlying reference entity, an identical maturity, and an identical fixed premium, at least one of the one or more servers is configured to consolidate the at least two credit derivative products into a single combined position. Each of the one or more servers may include a server computer residing on a network. The interface may include a network connection through which a client computer can access at least one server computer. The network may be the Internet.

For a given credit derivative product, an amount of the fixed premium may be equal to a credit default swap par rate. Alternatively, for a given credit derivative product, an amount of the fixed premium may not be not equal to the credit default swap par rate. For a given credit derivative product, an amount of the fixed premium may be expressed either in basis points per annum or in cash value, or in any other format that can be understood by market participants. The fixed premium may be paid on a daily basis or on a quarterly basis, or on any other predetermined periodic basis.

In another aspect, the invention provides a method of trading a credit derivative product. The product includes a fixed premium to be paid by a buyer to a seller on a predetermined periodic basis. The method includes the steps of enabling users to submit bids or offers relating to the credit derivative product; comparing submitted bids to submitted offers to determine at least one match; and using the at least one match to execute a trade. When at least two executed trades involve credit derivative products having an identical underlying reference entity, an identical maturity, and an identical fixed premium, the method further includes the step of consolidating the at least two executed trades into a single combined position.

An amount of the fixed premium may be equal to a credit default swap par rate for the credit derivative product. Alternatively, an amount of the fixed premium may not be equal to the credit default swap par rate for the credit derivative product. An amount of the fixed premium may be expressed either in basis points per annum or in cash value, or in any other format that can be understood by market participants. The fixed premium may be paid on a daily basis or on a quarterly basis, or on any other predetermined periodic basis.

In yet another aspect, the invention provides a credit derivative product. The credit derivative product has a maturity date and a credit default swap par rate. The credit derivative product includes a fixed premium to be paid by a buyer to a seller on a predetermined periodic basis. The credit derivative product is configured to be traded on an exchange, and as a consequence, creates a capability to combine multiple trades into a single trading position (gross or net) and to maintain consolidated positions for which all such trades have the same underlying reference entity, maturity, and fixed premium. Accordingly, when at least two of the credit derivative products have an identical underlying reference entity, an identical maturity, and an identical fixed premium, the exchange is configured to consolidate the at least two credit derivative products into a single combined position.

An amount of the fixed premium may be equal to the credit default swap par rate. Alternatively, an amount of the fixed premium may not be equal to the credit default swap par rate. An amount of the fixed premium is expressed either in basis points per annum or in cash value, or in any other format that can be understood by market participants. The fixed premium may be paid on a daily basis or on a quarterly basis, or on any other predetermined periodic basis.

### BRIEF DESCRIPTION OF THE DRAWINGS

FIG. 1 illustrates a block diagram of a system for facilitating trading of credit derivative products having fixed premiums according to a preferred embodiment of the invention.

FIG. 2 is a flow chart that illustrates a method of trading credit derivative products having fixed premiums according to a preferred embodiment of the invention.

### DETAILED DESCRIPTION OF THE INVENTION

The financial markets for credit products have developed dramatically in recent years. The purpose of credit products is to provide the investor with an increase or decrease in its exposure to the credit risk of a specific borrower, or collection of borrowers, and thereby improve the risk adjusted returns on their investments.

The credit risk of a borrower is the risk that the borrower will not pay the money it is obliged to pay under the terms of its borrowing agreement. When the borrowing takes the form of a loan, the typical payments that borrowers are obliged to pay are the amount originally borrowed plus any interest charges. When the borrowing takes the form of a bond, the typical payments that borrowers are obliged to pay are the notional value of the bond plus any coupon payments on the bond.

Should the borrower fail to make any such payment, the lender of the funds will suffer a financial loss. The financial risk to the lender is therefore related to the likelihood of the borrower failing to make the payments, and to the amount which in the circumstances of a failure to make payment the lender could lawfully reclaim from the borrower.

The financial risk which is borne by the lender has a value. Typically, a higher perceived credit risk would be associated with a higher cost of funding—for example, a higher interest rate on a loan or a higher initial yield on a bond.

The financial markets for credit products that have been developed in recent years have two significant purposes: to enable additional investors to enter the market to participate in the higher returns potentially available to lenders in the market; and to provide a mechanism for lenders to reduce their exposure to the credit risk of their counterparties. As with other financial markets, other firms and individuals support this risk transfer process through their actions as market makers and brokers.

The main financial derivative product that has developed for the purpose of transferring credit risk is the credit default swap (“CDS”). The CDS market has developed in the over-the-counter environment. The structure of a CDS takes the form of a legal contract to transfer cash flows and assets at future dates. The counterparties to the transaction are referred to as the protection buyer and the protection seller. The borrower on which the transaction is based is referred to as the reference entity, and is not normally a party to the contract. The transaction results in the protection buyer being provided with a compensating payment by the protection seller in a situation where the reference entity fails to honor its borrowing commitments (in terms defined in the CDS contract) to any third party. Such a situation is generally referred to as a “credit event”. Typically there is a series of “fixed side” payments which are of a predetermined size and made by the protection buyer to the protection seller on predetermined dates for the lifetime of the contract. There is also a “floating side” payment made by the protection seller to the protection buyer. The floating side payment is only made when a credit event has occurred; therefore it is often the case that CDS contracts do not result in a floating side payment being made. The floating side payment can take one of two forms—physical settlement and cash settlement. A physical settlement payment involves the protection seller paying the par amount of a loan or bond of the reference entity and taking delivery of the loan or bond from the protection buyer. A cash settlement payment involves establishing an agreed value for a loan or bond of the reference entity and the protection seller making a payment equal to the difference between this agreed value and the par value of the loan or bond to the protection buyer.

Importantly for the new product described herein, when a credit event does occur, the structure of the CDS contract is such that no further fixed payments are made by the protection buyer to the protection seller (other a final payment reflecting the accrual of value of fixed payment from the date of the last actual payment to the date the credit event is deemed to have occurred by the parties).

Investment exchanges worldwide have been seeking to develop credit derivative products to offer their services to this growing market. The new product according to a preferred embodiment of the present invention, described herein, is such a product.

The new product according to a preferred embodiment of the present invention differs to the credit products which have already been proposed by investment exchanges. All such products seek to provide investors with a risk control mechanism for credit exposures, and therefore the financial payoffs to buyers and sellers are similar, and are comparable to those of the CDS market. However, the mechanisms by which the products achieve these payoffs differ considerably.

In a first currently available design, the long term (e.g., five years) of a CDS contract is broken down into a series of shorter term contracts (three months). The shorter term contracts correspond to the frequency of payment of the fixed side of a CDS, and therefore each contract represents a single three month contract for credit risk protection. The price assigned to the contract corresponds to the fixed side payment made in a CDS contract. To replicate a longer term CDS position, a series of contracts with successive maturities can be entered into. As each maturity is an independent contract in its own right, investors can combine contracts in different series to create overall positions which have a shorter or longer term, or positions that are for forward starting protection. The short term nature of each contract means that investors can readily modify their risk exposure at specific forward starting points.

When a credit event occurs, holders of the nearest maturing contract are exposed to default protection—as either buyer or seller. A new contract is created to replicate the compensation payment from protection seller to protection buyer, and holders of the nearest maturing contract are granted positions in this new contract in accordance with their position in the nearest maturing contract. The contract is based on the standard approach of futures contracts, where cash payments are not paid up front (they are deferred until the future), positions are assigned a value daily and the profit or loss made on a position due to this revaluation is paid by all parties as soon as practically possible (typically the next business day). This process is known generally as “marking to market”.

One feature of this first current contract design is that when a credit event occurs, delivery months other than the nearest maturing contract are assigned a value of zero; i.e., the protection buyer will no longer receive a compensation payment from this delivery month, and so the value to the protection buyer is zero. Assigning a value of zero to the further maturities, combined with the mark-to-market nature of the product, results in protection buyers effectively paying for future unused protection at the time of a default. This differs from the CDS market mechanism of ceasing the fixed payment stream at the time of the credit event. It is anticipated that this difference in treatment will result in lower values being assigned to future protection exposures within this first current contract design when compared to the CDS market.

A second contract design is also currently available for trading. This second product provides a single term exposure to credit risk—a single contract offers the protection buyer protection over a longer term (e.g., multiple years). Contracts of different maturities, and therefore overlapping exposures in the shorter term, will be listed to provide the investor with different investment terms. The price assigned to the contract corresponds to the fixed side payment made in a CDS contract.

When a credit event occurs, the holders of all contracts receive (in the case of buyers) or pay (in the case of sellers) a compensation amount representing the financial loss on the defaulted underlying asset. As with the first contract design as described above, the contract is based on the standard approach of futures contracts, where positions are revalued and marked to market daily. Similar to the first contract design, where a credit event occurs, the remaining value of each contract becomes zero—the protection buyer will no longer receive a compensation payment from position and so the value to the protection buyer is zero. Assigning a value of zero to contracts, combined with the mark-to-market nature of the product, results in protection buyers effectively paying for future unused protection at the time of a default. This differs from the CDS market mechanism of ceasing the fixed payment stream at the time of the credit event. It is anticipated that this difference in treatment will result in lower values being assigned to protection exposures within the second contract design when compared to the CDS market.

A third currently available contract design is based on the CDS market quotation for CDS of a specific maturity (e.g., a five year maturity). The third product is a more typical “futures” contract when compared to either the first design or the second design, in that the maturity of the exchange traded contract (for example six months) differs from the maturity of the underlying value (for example five years). The price assigned to the contract corresponds to three elements: the remaining notional value of the underlying reference; the difference in value between an anticipated future CDS quote on the contract's maturity and a known CDS quote at the contract's inception; and the accrued protection payment made on a CDS contract created at the time the future's contract was first listed.

Unlike the first and second designs, in the third contract design, a CDS position cannot be replicated in the longer term. Each contract will be available for a period of six months, and during this period the contract does effectively replicate a CDS of the term corresponding to the underlying asset (e.g., five years). However, when the contract expires, a new contract is introduced and referenced again to the same standard maturity (e.g., five years). This differs from a CDS contract which has an enduring structure which would have a shortened maturity (e.g., four and a half years) at this point in time. Entering into consecutive positions of the third type of contract maintains a relatively constant exposure to five year credit risk, but the time exposure does not fall to zero as it does in the CDS market, or as it does with the first and second contract designs.

When a credit event occurs, the holders of all contracts receive (in the case of buyers) or pay (in the case of sellers) a compensation amount representing the financial loss on the defaulted underlying asset. As with the first and second contract designs, the third type of contract is based on the standard approach of futures contracts, where positions are revalued and marked to market daily. Unlike the first and second designs, when a credit event occurs with respect to the third design, buyers of protection do not suffer a financial loss when compared to the CDS market. The notional value and accrued protection payment elements of the contract price are adjusted to reflect the revised market conditions. As described above, the third type of contract does this only in restricted circumstances—during the short term maturity of the currently available contract. The maximum period the third type of contract can replicate a CDS contract is six months.

Both of the first and second product designs described above will result in higher payments by protection buyers in the case of a credit event compared to a CDS. This outcome results from the design specification of having the contract value related to current market price, as is normal for exchange traded futures and options contracts. At the point at which there is a credit event, there is no value in future protection, therefore the price changes to zero, with the knock on implication that the mark-to-market process requires that this price change is associated with a higher payment by the buyer. With these contract designs no reasonable verifiable contract value can be established. By comparison, the CDS contract has a series of fixed future payments which can be discontinued in the case of a credit event. Discontinuing the payments in the case of the CDS means that the protection payment is not made, rather than made in full.

Futures and options contracts traded at investment exchanges bring standardization and efficiency to financial markets. The typical definition of a futures contract is an agreement to transfer a predetermined quantity of an asset of predetermined quality on predetermined future date using a predetermined mechanism at a price agreed today. The price at which the contract trades is usually identified as the price at which the asset will be transferred in the future. However, this is not the case in practice, as the exchange controlling the futures contract will set a price (often referred to as an “Exchange Delivery Settlement Price”, or “EDSP”) at which the delivery of all contracts will be made. The difference between the trade price and the EDSP is accounted for using another standard feature of futures markets—i.e., marking to market. This process updates the valuation of all open positions and requires the transfer of profit or loss on a frequent (typically daily) basis. The traded price of a futures contract is therefore translated into delivery value by the summation of periodic mark-to-market payments together with delivery at the EDSP.

Unlike the underlying asset the contract size and the maturity, the initial price of the transaction is not an identifiable attribute of a transaction. Rather, the price of all contracts is updated frequently, and all contracts are associated with the same price and indistinguishable, regardless of the timing and the price of the original transaction. Being indistinguishable in this way can be seen as advantage to market users as it means all positions are treated the same when it comes to trading. In other words, there is no inherent value distortion in competing quotations due to the positions on which they are based having different initial values.

Option contracts provide the buyer with the right to buy (i.e., a call option) or the right to sell (i.e., a put option) an underlying asset. Thus, option contracts result in the option seller having a corresponding obligation to sell (i.e., a call option) or buy (i.e., a put option) the underlying asset at the behest of the buyer. Compared to futures contracts, options have additional attributes: they have the exercise price at which the underlying asset may by transferred, and they have the nature of the conditional future transaction—it is either a purchase (call) or a sale (put) as viewed from the point of view of the option buyer. Despite this, the principle described above for futures contracts applies to options contracts as they appear on investment exchanges. For a given set of attributes, all contracts have the same price. The initial price for opening a position does not affect the current value or pricing in the market for that position.

The contract design of the present invention deals with the problems faced by existing proposals for exchange traded credit derivative contracts. The invention does this by the inclusion of a fixed payment for the transaction as a new trade attribute (referred to herein as the “fixed premium”). The fixed premium is the amount the protection buyer pays for the protection on an ongoing basis. In comparison to a typical CDS contract which trades at par, the fixed premium will be the transaction price for the CDS trade.

It is not necessary for contract under the proposed new design to trade with a fixed premium equal to the CDS market par rate. Should a contract with a different fixed premium trade, there will be an additional payment to be made by (or to) the protection buyer, in accordance with the trade value. For a contract with a fixed premium below the current market rate, the trade value will be an amount paid by the buyer to the seller. For a contract with a fixed premium above the current market rate the trade value will be an amount paid by the seller to the buyer.

Within this description, there are a number of terms related to price and value. These are defined here as follows:

“Fixed Premium” is the payment that is made from protection buyer to protection seller as payment for the protection. Within the proposed design it is a fixed amount, and can be expressed either in basis points per annum, or a cash value which represents this amount for the known notional size of the contract/transaction.
“Market rate” or “par premium” is the current market price for a CDS. It is expressed in basis points per annum, and is a par rate because it the rate at which the expected value of the fixed side and the expected value of the floating side are equal—thus making the overall value zero.
“Contract price” is the price at which a contract with the proposed contract design, with a known maturity and fixed premium, is traded. This is measured in basis points per annum. The contract price is going to be determined by the market, but is expected to be in line with the CDS par premium.
“Contract Value” is the capital value of a contract with proposed contract design with a known maturity and fixed premium. This is measured as a cash value.
“Trade Value” is the contract value (as described above) at the time of trade, and represents the actual amount transferred between buyer and seller for the contract in question.

When creating a CDS position, the price traded becomes the reference rate for the quarterly fixed payments. Two CDS positions, one to buy and one to sell, can co-exist in a portfolio and each can be identified by the fixed payment amount that must be paid.

Including the fixed premium as an attribute in an exchange traded product modifies the way the products are managed in an exchange environment. With traditional futures contracts, all positions in a given delivery month are collated together. Buy and sell positions may be netted off against each other where appropriate. In this manner, different transaction prices for these positions result in a realized profit or loss. In the proposed contract structure, positions are only collated together where the delivery month and fixed premium are the same. Buy and sell transactions at different fixed premiums result in two offsetting positions being created, rather than a single net (potentially zero) position. This replicates the CDS market process.

The use of the fixed premium as a separate contract attribute can be seen as being similar in principle to the addition of exercise price as an attribute for option contracts—option positions are only amalgamated where expiry month and exercise price match. It should be stressed that the proposed contracts are not options—no option rights are created for the buyer or seller. The fixed payment associated with the contract is calculated directly from this fixed premium value. It should be noted that this fixed payment could be made periodically (e.g., every three months) like CDS contracts, or daily via variation margin like the each of the proposed alternative exchange traded credit derivative products from the exchanges.

By establishing fixed premium as a trade attribute, the situation is created that for any given delivery month there will be positions held at multiple fixed premium levels. Buy and sell positions of the same size at differing fixed premium levels in the same delivery month will not net down to zero as they would if they were traditional futures contracts, but the combination of the two positions would create a net zero exposure to credit risk through the two contracts. In other words, the underlying credit risk for the two contracts would be the same and offsetting. The differing fixed payment amounts on the two contracts may result in a risk exposure to changes in interest rates, however.

In addition to being an additional trade attribute, the fixed premium has a more fundamental role in the product design. The fixed premium represents an ongoing payment stream from buyer to seller, and as such this product design differs from previous designs for exchange traded derivatives contracts. For other exchange traded derivatives contracts, value transfer between buyer and seller occurs through a change in the price of the contract and associated marking-to-market. With this new contract design, the fixed payment will be transferred from buyer to seller regardless of whether there is a change in contract price or contract value.

The contract design of the present invention also solves the problem inherent in other designs of crystallizing future fixed payments at the occurrence of a default. This problem occurs because those contract designs rely on the current market value of a fixed payment to identify the market-to-market value that should be set—as the future fixed payment becomes zero when there is a default, the mark-to-market value also becomes zero, thus requiring a cash flow from buyer to seller. There is no external valuation available for this cash flow to avoid this scenario, and no reliable mechanism for preventing this cash flow occurring. By contrast, in the proposed contract design according to a preferred embodiment of the present invention, the mark-to-market value is not linked to the fixed payment value in the same way—each set of fixed payments identified as a contract has its own mark-to-market value, but the size of the fixed payment is separate (and truly fixed). When a default occurs with the proposed contract, the correct amount of fixed payment can be identified (correct in the sense that it matches the CDS contract) with reference to the fixed premium level. Future fixed payments can be discontinued without the result that buyers must pay sellers the total amount.

A sample set of contract terms can be described as follows.

| Item | Description |
|---|---|
| Unit of Trading | Default protection on $100,000 notional principal |
| | Single name or Index underlying |
| Delivery Months | Quarterly maturities listed, on March, June, |
| | September, December cycle |
| | 21 delivery months listed |
| Maturity | Each delivery month offers default protection from |
| | the date of trade up to and including the Last Trading |
| | Day |
| Fixed Payment | Basis points per annum of notional |
| Premium | 0.01 minimum differential |
| Initial Trade | Paid by the buyer to the seller, or from the seller to |
| Value | the buyer, as appropriate depending on the relative |
| | sizes of the Fixed Payment Premium and the Trade |
| | Price. Paid in full at the time of trade. |
| Quotation | Basis points per annum of notional |
| | 0.01 minimum price movement |
| Tick Value | Depends on number of days in protection period, and |
| | amount of surviving notional for index contracts |
| | 0.01 bp approx. equal to $0.10 per $100k notional |
| | per annum |
| Trading Hours | 07:00-18:00 hours London time |
| Daily Settlement | Prices established a 16:15 hours London time for |
| | variation margin purposes |
| | Settlement prices will be $ per $100 notional |
| Fixed Premium | Fixed premium is paid daily via variation margin- |
| Payments | and is incorporated into the mark-to-market process |
| Last Trading Day | 20^{th} calendar day of delivery month or next following |
| | business day |
| Final Settlement | $0.00 (zero) |
| Price (EDSP) | |
| Credit Event | Delivery of “Event Protection Contract” to all |
| Delivery | positions holders. |
| | No further fixed premium payments are made. |

There is standard transformation process which converts a value expressed in basis points into a value expressed in cash terms. The final settlement price of zero reflects the fact that the buyer of the position no longer has protection against a credit event and therefore there is a zero value to the position.

Should a credit event occur with the proposed new contract design, the resultant compensation payment structure is the same as that described in the first currently available product design as described above. In the case of a credit event, buyers and sellers of all contracts are granted positions in a new contract, i.e., the “event protection contract”, which provides the compensation payment from seller to buyer. At the time the event protection contract is issued, fixed payments associated with the contract cease being made.

The contracts specification highlighted in the table above can be amended in a number of ways without affecting the basic design features described. These alternatives are as follows:
i) The fixed payment amounts may be paid by the buyer to the seller on a daily basis (as shown), on a quarterly basis (as with a CDS contract) or to any other time frame.
ii) The initial trade value may be paid at the time of trade, or it may be held on account and transferred between counterparties through the mark-to-market mechanism.
iii) The contracts describes herein are spot contracts; i.e., they offer protection from the day of trade. It is possible to create contracts which offer forward starting protection using the proposed contract design. In that case, the fixed premiums would not begin to be paid until a future date.
iv) Terms such as the unit of trading, notional size, maturity, number of delivery months, minimum price movement, trading hours may be altered without impact on the design concept.

The proposed product design according to a preferred embodiment of the present invention is intended to be similar in nature to CDS contracts. The substantial difference is that the proposed design provides a mechanism for contracts like CDS to be traded on an exchange. CDS contracts are traded in the over the counter (OTC) market, and are bilateral contracts. Each CDS transaction is held independently of other transactions. The proposed contract offers an opportunity for different transactions with the same attributes of maturity and fixed premium to be held together, or to be netted out against each other—i.e., buy and sell transactions in contracts with same maturity and fixed premium can net down to a zero position, rather than merely being offsetting open positions. In that situation, the exchange is doing more than just facilitating the transaction of bilateral contracts which the OTC market and trading venues which support the OTC market offer; in addition, the exchange is offering a mechanism for position management for credit default products which is the norm for futures and options contracts.

In a preferred embodiment, the present invention provides an apparatus, a method, and a set of credit derivative products which can be used for the efficient trading of credit risk exposure. The credit derivative products are designed to sit within the credit derivatives market as it exists today, and the design concept is similar in nature to a CDS in that an investor can buy protection against a credit event in exchange for payments to the protection seller.

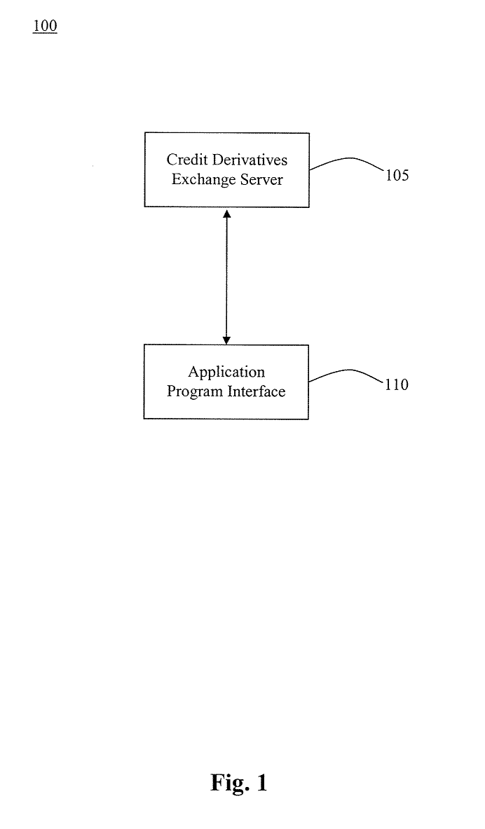

The general transaction element of these credit derivative products, according to a preferred embodiment of the invention, can be described as having the following distinct characteristics:
Referring to FIG. 1, each product can be traded on an investment exchange or other multi-user trading system, such as system 100.
The underlying reference entity for each credit derivative product is an established credit index, a portfolio of bonds and/or loans from a list of issuers, bonds and/or loans from a single issuer, or a specific bond or loan from a single issuer.
The trading of each credit derivative product includes a fixed premium payment as an attribute of the trade.
Trading occurs on an exchange or other multi-user trading system which, inter alia, facilitates the maintenance of an investor's consolidated net positions, which may comprise multiple transactions having identical maturities and fixed premiums.
The system 100 facilitates trading of the credit derivative products by enabling a customer to enter a bid or an offer for a credit derivative product via the application program interface (API) 110. The host server 105, which may comprise one or more server computers, is connected via a network, such as a local area network (LAN), wide area network (WAN), or the Internet, to all APIs 110, and in this manner receives all entered bids and offers. The host server 105 then matches received bids and offers to execute trades.
The system 100 incorporates a mechanism at the host server 105 for accommodating “credit events”—such that one counterparty (i.e., the “protection buyer”) receives a compensation when such a credit event occurs from the other counterparty (i.e., the protection seller).
A central organization (for example, the exchange) is responsible for determining when a credit event has occurred.
The contract can operate with or without the support of a clearing house which acts as central counterparty to all contracts.
   As noted above, the underlying reference for each product may be any one of an established credit index, a portfolio of bonds and/or loans from a list of issuers, bonds and/or loans from a single issuer, or a specific bond or loan from a single issuer. Alternatively, the underlying reference for each product may be a market sector, such as an aviation sector, an industrials sector, a pharmaceuticals sector, a foods sector, an energy sector, a financials sector, a telecommunications sector, an information technology sector, a general transportation sector, a minerals and mining sector, and a geographical reference such as Europe or South America. The market sector may be a subset within an established credit index, or the market sector may be a subset of an entire market and thus not confined to a specific index.

The host server 105 is preferably implemented by the use of one or more general purpose computers, such as, for example, a Sun Microsystems F15k, or a Hewlett-Packard ProLiant DL580. Each API 110 is also preferably implemented by the use of one or more general purpose computers, such as, for example, a Dell Dimension 5150 Pentium 4 or a Hewlett-Packard ProLiant DL 380 G4. Each of the host server 105 and the API 110 can include a microprocessor. The microprocessor can be any type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), or the like. Each of the host server 105 and the API 110 can also include computer memory, such as, for example, random-access memory (RAM). However, the computer memory of each of the host server 105 and the API 110 can be any type of computer memory or any other type of electronic storage medium that is located either internally or externally to the host server 105 or the API 110, such as, for example, read-only memory (ROM), compact disc read-only memory (CDROM), electro-optical memory, magneto-optical memory, an electrically-erasable programmable read-only memory (EEPROM), or the like. According to exemplary embodiments, the respective RAM can contain, for example, the operating program for either the host server 105 or the API 110. As will be appreciated based on the following description, the RAM can, for example, be programmed using conventional techniques known to those having ordinary skill in the art of computer programming. The actual source code or object code for carrying out the steps of, for example, a computer program can be stored in the RAM. Each of the host server 105 and the API 110 can also include a database. The database can be any type of computer database for storing, maintaining, and allowing access to electronic information stored therein. The host server 105 preferably resides on a network, such as a local area network (LAN), a wide area network (WAN), or the Internet. The API 110 preferably is connected to the network on which the host server resides, thus enabling electronic communications between the host server 105 and the API 110 over a communications connection, whether locally or remotely, such as, for example, an Ethernet connection, an RS-232 connection, or the like.

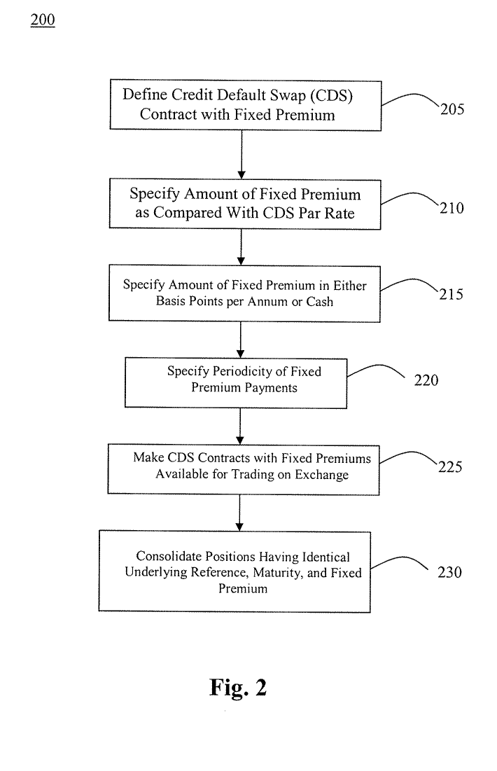

Referring to FIG. 2, a flow chart 200 illustrates a process that is executed by the system 100 for facilitating trading of credit derivative products having fixed premiums, according to a preferred embodiment of the present invention. In the first step 205, a credit default swap (CDS) contract is defined as including a fixed premium payment as an attribute of the contract. In the second step 210, an amount of the fixed premium payment is specified in comparison with the CDS par rate. In this manner, the fixed premium payment may or may not be equal to the CDS par rate. An initial trade value is determined, reflecting any difference between the fixed premium payment and the CDS par rate. It is noted that the initial trade value would be equal to zero whenever the fixed premium payment is equal to the CDS par rate. Then, at step 215, the amount of the fixed premium is expressed either in basis points per annum, as a cash value, or in some other units of currency that would be understood by typical market participants. At step 220, the periodicity of the fixed premium payments is also specified. Typically, the fixed premium payments may be made on a daily basis or on a quarterly basis, but any predetermined periodicity may be used. At step 225, the CDS contracts with fixed premiums are made available for trading on an exchange. At step 230, the exchange consolidates any CDS contracts that have an identical underlying reference entity, an identical maturity, and an identical fixed premium into a single combined position, in order to promote efficiency of the trading environment.

The contract design according to a preferred embodiment of the present invention is very different from the third currently available contract design as described above. This third design offers short term exposure (e.g., each contract only last three months or six months) on a long term quotation. By contrast, the contract design of the present invention offers a long term exposure directly, rather than just the price risk of such an exposure. More fundamentally, the proposed design of the present invention takes a new approach (for an exchange traded derivative) for managing the fixed premium element of the credit default swap transaction. The third product evaluates the daily accrual of the fixed side of the swap transaction, and adds this accrued value to the total value of the contract. The fixed payment therefore becomes part of the capitalized contract value, and is expressed as part of the quoted price of the contract. The proposed design of the present invention also assesses the amount of the fixed premium payment on a daily basis; however, this payment is not added to the contract's value or price quotation. The fixed premium payments are handled as a separate cash flow within the structure, and not simply added to the contract's value. One implication of this is that the fixed premium payment element of the product could potentially be treated as income rather than capital growth from a tax and regulatory point of view.

The second currently available contract design, also described above, takes another approach to managing the value transfer of the fixed payment from the buyer to the seller. In the second design, the value of the fixed payments to be made over the life of the product are summed and form the quoted price of the contract. Therefore, as with the third design, the fixed payment forms part of the capital value of the product. Over time, the value of fixed payments over the remainder of the life of the contract falls (other things being equal) as time to maturity falls. The fixed payment is transferred from buyer to seller via a change in value of the contract. This again differs from the proposed design according to a preferred embodiment of the present invention, which holds the fixed payment as a separate cash flow from the value of contract.

Furthermore, as the market price for a par CDS changes, the valuation of the second currently available contract changes. The implication of this is that changes in the par (market) rate affect the capital value of all positions—there is no truly fixed side to this contract. As the market rate changes, a profit/loss is presented to the holder of an existing position, but the new value builds in the concept that all position holders continue to pay the fixed side of the contract at the new market rate, rather than at the prevailing rate at which each deal was struck. With the proposed design, the fixed premium payment is unchanged through the life of the contract. As with the OTC market, the valuation of this future cash flow changes as the market par rate changes.

The second currently available contract design also has the property that when there is a credit event in the contract, the price structure results in the buyer paying the seller the full fixed payment amount for the remainder of the life of the contract. This differs from the CDS market, where fixed payments cease at the point where a credit event occurs. In the proposed design according to a preferred embodiment of the present invention, because the fixed premium payment is separated from the capital value of the contract, the buyer is not required (either explicitly or implicitly) to pay fixed payment for the remaining term of the contract. The fixed premium payment element can cease at the time of the credit event.

The first and second currently available contract designs are similar in that the value of the fixed payment to be made during the active period of a delivery month forms the quoted price of the contract. The fixed premium payment forms part of the capitalized value of the contract. By contrast, in the proposed design according to a preferred embodiment of the present invention, the fixed premium payment is a separate cash flow. The first and second currently available contract designs are also similar in the feature that contract values are reset to reflect changes in the market par rate for CDSs. At any given point in time, all positions are going to pay or receive the market rate for the fixed side. By contrast, in the proposed design according to a preferred embodiment of the present invention, holders of each contract pay or receive a known fixed rate for the life of the contract.

The first currently available product design also has the property that when there is a credit event in the contract, the price structure results in the buyer paying the seller the full fixed payment amount for the remainder of the life of the contract. By contrast, in the proposed design according to a preferred embodiment of the present invention, because the fixed premium payment is separated from the capital value of the contract, the buyer is not required (explicitly or implicitly) to pay fixed payment for the remaining term of the contract. The fixed payment element can cease at the time of the credit event.

The following text provides examples of positions in the new contract design according to a preferred embodiment of the present invention, and the change in value of these positions over a period of time.

### EXAMPLE 1

Trade 1 is a new position created on Day 1 at the market par rate of 60 basis points (“bp”).

| | | Fixed | Trade Price/ | Trade | Contract |
|---|---|---|---|---|---|
| Reference | Maturity | Premium | Market Rate | Value | Value |
| Trade 1 | December 2010 | 60 bp | 60 bp | $0.00 | $0.00 |

The fixed premium is equal to the trade price, which represents the par premium in the market, and as a result, the trade value is zero and the contract value is zero. The value per lot reflects the net present value of the known fixed premium payments to be paid by the buyer of the contracts, and the estimated but unknown floating payment to be paid to the buyer should there be a default. The value of $0.00 reflects the fact that the position is transacted at par. In other words, the net present values of the fixed and floating sides are equal and opposite.

### EXAMPLE 2

Trade 2 is a new position created on Day 1 with a fixed payment different to the market par rate of 60 basis points.

| | | Fixed | Trade Price/ | Trade | Contract |
|---|---|---|---|---|---|
| Reference | Maturity | Premium | Market Rate | Value | Value |
| Trade 2 | December | 50 bp | 60 bp | $364.03 | $364.03 |
| | 2010 | | | | |

The fixed premium for this transaction is 50 basis points, which differs from the current market par premium of 60 basis points. The trade price, 60 basis points, represents the price at which the trade is entered into. Accordingly, the trade price of 60 basis points will be the price in basis point terms for all contracts with maturity of December 2010.

The effect of purchasing a non-par contract occurs in the establishment of the contract value and trade value. The trade value is the value that will be assigned to the position in the exchange's systems. It is established using a market standard pricing method which does not form part of this product description. The trade value is transferred from the buyer to the seller which compensates the seller for agreeing to receive a fixed payment at below the market rate. Should there be no change in the market premium of 60 basis points, the contract value of $364.03 per lot will tend to zero over the life of the contract—which should be the case as the market price for the credit risk is greater than the 50 basis points set as the fixed payment.

### EXAMPLE 3

Trade 1 is held for a period of time. The market CDS price remains unchanged over the period.

| | | | | Contract | | |
|---|---|---|---|---|---|---|
| | Value | Fixed | Trade Price/ | Value | Fixed | Daily Cash Flow |
| Reference | Date | Premium | Market Rate | Per Lot | Payment | Per Lot |
| Trade 1 | Day 1 | 60 bp | 60 bp | $0.00 | | |
| | Day 2 | 60 bp | 60 bp | $0.00 | −$1.67 | −$1.67 |
| | Day 3 | 60 bp | 60 bp | $0.00 | −$1.67 | −$1.67 |
| | Day 4 | 60 bp | 60 bp | $0.00 | −$1.67 | −$1.67 |
| | Day 5 | 60 bp | 60 bp | $0.00 | −$1.67 | −$1.67 |
| | Day 6 | 60 bp | 60 bp | $0.00 | −$1.67 | −$1.67 |

As the market price does not change, positions will continue to have a value of zero. The cash flow associated with these contracts is made up of two elements: the change in value per lot (zero in this example); and the daily mark-to-market of the fixed premium payments. For each calendar day, a fixed payment of 60 basis points will equate to a payment amount of $1.67, from the buyer to the seller.

### EXAMPLE 4

Trade 1 is held for a period of time, during which the market CDS price falls.

| | | | | | | Daily |
|---|---|---|---|---|---|---|
| | | | Trade | | | Cash |
| | | | Price/ | Contract | | Flow |
| Ref- | Value | Fixed | Market | Value Per | Fixed | Per |
| erence | Date | Premium | Rate | Lot | Payment | Lot |
| Trade 1 | Day 1 | 60 bb | 60 bp | $0.00 | | |
| | Day 2 | 60 bp | 59 bp | −$36.39 | −$1.67 | −$1.67 |
| | Day 3 | 60 bp | 58 bp | −$72.74 | −$1.67 | −$1.67 |
| | Day 4 | 60 bp | 57 bp | −$109.07 | −$1.67 | −$1.67 |
| | Day 5 | 60 bp | 56 bp | −$145.36 | −$1.67 | −$1.67 |
| | Day 6 | 60 bp | 55 bp | −$181.62 | −$1.67 | −$1.67 |

The effect of the change in market price has a negative effect on the position value. In this example, the position is given a negative value when the market price falls below the position's fixed premium. A negative value indicates that should the protection buyer wish to close out the position, the new buyer will be compensated by the seller (i.e., the original protection buyer) for having to pay a fixed payment higher than market values.

Some technology systems cannot support a value that can vary between positive and negative values. In this case, an exchange may decide to rebase the position value amount to another number (e.g., $100,000). This does not change the principle that the value will move up or down in response to changes in the market price for credit protection.

In Example 4 above, the daily cash flow does not include the change in contract value. This reflects the notion, described above, that contract values are transferred at the time of trade only. In this situation, changes in contract values are therefore not capitalized and transferred on a regular basis (e.g., daily). An alternative design, however, could have trade values being held on account and transferred over time through the mark-to-market process. Accordingly, in this alternative design, the cash flows would be as follows:

| | | | | | | Daily |
|---|---|---|---|---|---|---|
| | | | Trade | | | Cash |
| | | | Price/ | Contract | | Flow |
| Ref- | Value | Fixed | Market | Value | Fixed | Per |
| erence | Date | Premium | Rate | Per Lot | Payment | Lot |
| Trade 1 | Day 1 | 60 bp | 60 bp | $0.00 | | |
| | Day 2 | 60 bp | 59 bp | −$36.39 | −$1.67 | −$38.05 |
| | Day 3 | 60 bp | 58 bp | −$72.74 | −$1.67 | −$38.02 |
| | Day 4 | 60 bp | 57 bp | −$109.07 | −$1.67 | −$37.99 |
| | Day 5 | 60 bp | 56 bp | −$145.36 | −$1.67 | −$37.96 |
| | Day 6 | 60 bp | 55 bp | −$181.62 | −$1.67 | −$37.93 |

### EXAMPLE 5

Trade 2 is held for a period of time, during which the market CDS price falls.

| | | | | | | Daily |
|---|---|---|---|---|---|---|
| | | | Trade | | | Cash |
| | | Fixed | Price/ | Contract | | Flow |
| Ref- | Value | Pre- | Market | Value Per | Fixed | Per |
| erence | Date | mium | Rate | Lot | Payment | Lot |
| Trade 2 | Day 1 | 50 bp | 60 bp | $364.03 | | −$364.03 |
| | Day 2 | 50 bp | 59 bp | $327.49 | −$1.39 | −$1.39 |
| | Day 3 | 50 bp | 58 bp | $290.97 | −$1.39 | −$1.39 |
| | Day 4 | 50 bp | 57 bp | $254.49 | −$1.39 | −$1.39 |
| | Day 5 | 50 bp | 56 bp | $218.04 | −$1.39 | −$1.39 |
| | Day 6 | 50 bp | 55 bp | $181.62 | −$1.39 | −$1.39 |

The trade value of $364.03 is paid by the buyer to the seller on the day of trade. The effect of the change in market price has a negative effect on the position value. Because the trade value is paid in full at the time of trade, no further payment reflecting the change in value is required. The alternative approach, in which contract values are capitalized and transferred through the mark-to-market process, would result in the following cash flows:

| | | | Trade | | | Daily |
|---|---|---|---|---|---|---|
| | | | Price/ | Contract | | Cash |
| Ref- | Value | Fixed | Market | Value | Fixed | Flow |
| erence | Date | Premium | Rate | Per Lot | Payment | Per Lot |
| Trade 2 | Day 1 | 50 bp | 60 bp | $364.03 | | $0.00 |
| | Day 2 | 50 bp | 59 bp | $327.49 | −$1.39 | −$37.93 |
| | Day 3 | 50 bp | 58 bp | $290.97 | −$1.39 | −$37.90 |
| | Day 4 | 50 bp | 57 bp | $254.49 | −$1.39 | −$37.87 |
| | Day 5 | 50 bp | 56 bp | $218.04 | −$1.39 | −$37.84 |
| | Day 6 | 50 bp | 55 bp | $181.62 | −$1.39 | −$37.81 |

The cash flow on day 1 is zero, as trade value is not paid in full. Cash flows on subsequent days are higher as the change in contract value due to the price change is transferred daily.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A system for facilitating trading of credit derivative products, comprising:
one or more servers at which the credit derivative products are actively traded and/or processed; and
an interface in communication with at least one of the one or more servers, the interface being configured to enable a user to enter a bid or an offer relating to a credit derivative product,
wherein each of the credit derivative products includes a fixed premium to be paid by a buyer to a seller on a predetermined periodic basis; and
wherein at least one of the one or more servers is configured to accept bids and offers for each of the credit derivative products via the interface, and
wherein, when at least two of the credit derivative products have an identical underlying reference entity, an identical maturity, and an identical fixed premium, at least one of the one or more servers is configured to consolidate the at least two credit derivative products into a single combined position.

2. The system of claim 1, wherein each of the one or more servers comprises a server computer residing on a network, and the interface comprises a network connection through which a client computer can access at least one server computer.

3. The system of claim 2, wherein the network is the Internet.

4. The system of claim 1, wherein for a given credit derivative product, an amount of the fixed premium is equal to a credit default swap par rate.

5. The system of claim 1, wherein for a given credit derivative product, an amount of the fixed premium is not equal to a credit default swap par rate.

6. The system of claim 1, wherein for a given credit derivative product, an amount of the fixed premium is expressed in basis points per annum.

7. The system of claim 1, wherein for a given credit derivative product, an amount of the fixed premium is expressed in cash value.

8. The system of claim 1, wherein the fixed premium is paid on a daily basis.

9. The system of claim 1, wherein the fixed premium is paid on a quarterly basis.

10. A method of trading a credit derivative product, the product including a fixed premium to be paid by a buyer to a seller on a predetermined periodic basis, and the method comprising the steps of:
enabling users to submit bids or offers relating to the credit derivative product;
comparing submitted bids to submitted offers to determine at least one match; and
using the at least one match to execute a trade,
wherein, when at least two executed trades involve credit derivative products having an identical underlying reference entity, an identical maturity, and an identical premium, the method further includes the step of consolidating the at least two executed trades into a single combined position.

11. The method of claim 10, wherein an amount of the fixed premium is equal to a credit default swap par rate for the credit derivative product.

12. The method of claim 10, wherein an amount of the fixed premium is not equal to a credit default swap par rate for the credit derivative product.

13. The method of claim 10, wherein an amount of the fixed premium is expressed in basis points per annum.

14. The method of claim 10, wherein an amount of the fixed premium is expressed in cash value.

15. The method of claim 10, wherein the fixed premium is paid on a daily basis.

16. The method of claim 10, wherein the fixed premium is paid on a quarterly basis.

17. A credit derivative product, the credit derivative product having a maturity date and a credit default swap par rate, and the credit derivative product including a fixed premium to be paid by a buyer to a seller on a predetermined periodic basis, wherein the credit derivative product is configured to be traded on an exchange, and wherein when at least two credit derivative products have an identical underlying reference, an identical maturity date, and an identical fixed premium, the exchange is configured to combine the at least two credit derivative products into a single combined position.

18. The credit derivative product of claim 17, wherein an amount of the fixed premium is equal to the credit default swap par rate.

19. The credit derivative product of claim 17, wherein an amount of the fixed premium is not equal to the credit default swap par rate.

20. The credit derivative product of claim 17, wherein an amount of the fixed premium is expressed in basis points per annum.

21. The credit derivative product of claim 17, wherein an amount of the fixed premium is expressed in cash value.

22. The credit derivative product of claim 17, wherein the fixed premium is paid on a daily basis.

23. The credit derivative product of claim 17, wherein the fixed premium is paid on a quarterly basis.
